(19) United States
(12) Patent Application Publication
(10) Pub. No.: US 2007/0135327 A1
(43) Pub. Date: Jun. 14, 2007

(54) Bleach blast

(76) Inventor: Tamra Acheson, Sacramento, CA (US)

Correspondence Address: JAMES RAY & ASSOCIATES, 2640 PITCAIRN ROAD, MONROEVILLE, PA, 15146, US

(21) Appl. No.: 11/491,204

(22) Filed: Jul. 21, 2006

Related U.S. Application Data
(60) Provisional application No. 60/749,711, filed on Dec. 13, 2005.

(51) Int. Cl. C11D 17/00

(52) U.S. Cl. 510/445

(57) ABSTRACT

A laundry device used for bleaching. The laundry device comprises a container member having a predetermined shape and formed of a predetermined material and a bleaching agent disposed within the container member for providing a bleaching action when dispersed in a clothes washer.

### CROSS REFERENCE TO RELATED APPLICATIONS

This application is closely related to and claims benefit from U.S. Provisional Application Ser. No. 60/749,711 filed Dec. 13, 2005.

### FIELD OF THE INVENTION

The present invention relates, in general, to a bleaching agent, and, more particularly, the present invention relates to a bleaching agent that is in the form of a gel tab or a hard tablet.

### BACKGROUND OF THE INVENTION

Laundry day is a big chore for many people. This is particularly true of those people who for one reason or another are forced to use a Laundromat. Carrying several fully loaded baskets of clothing, a big bottle of bleach, a box of detergent, fabric softener or softeners and various other necessities can weigh down a person's arms. After several hours of fighting with these containers and clothes baskets the last thing a person wants to do is put away the clean laundry. It's no wonder that many people dread these days.

Further, when pouring bleach and detergent into the washer, its not uncommon to use too much bleach or to spill the contents of the container containing bleach and thereby ruining or damaging some items.

Thus, it would be advantageous for these people if there were a bleach product that would be dispensed in a gel or hard casing tablet that would provide all the bleaching power of liquid bleach.

### SUMMARY OF THE INVENTION

In a first aspect the present invention provides a laundry device used for bleaching. The laundry device comprises a container member having a predetermined shape and formed of a predetermined material and a bleaching agent disposed within the container member for providing a bleaching action when dispersed in a clothes washer.

### OBJECTS OF THE INVENTION

It is, therefore, one of the primary objects of the present invention to provide a bleaching agent that is disposed in a gel or hard casing pack.

Another object of the present invention is to provide a bleaching agent that is disposed in a gel or hard casing pack that is easy to carry.

Still another object of the present invention is to provide a bleaching agent that is disposed in a gel or hard casing pack which be either a liquid or a powder.

Yet another object of the present invention is to provide a bleaching agent that is disposed in a gel or hard casing pack that is soluble in water.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of the apparatus according to an embodiment of the invention showing a gel pack with a bleaching agent disposed therein.

FIG. 2 is a perspective view of the apparatus according to an alternate embodiment of the invention showing a hard casing with a bleaching agent disposed therein.

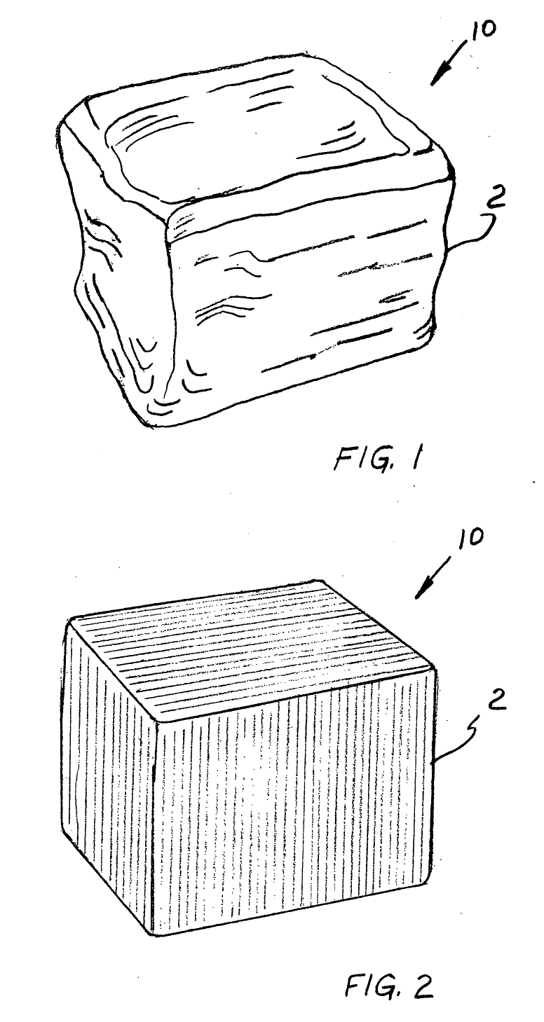

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides a laundry device, generally designated 10, which is used for bleaching. The laundry device 10 comprises a container member 2 having a predetermined shape and formed of a predetermined material and a bleaching agent disposed within the container member 2 for providing a bleaching action when dispersed in a clothes washer.

Such container member 2 is selected from one of a gel tab and a hard casing. Generally the difference being the end use of the container member.

In a first embodiment the container member 2 is used wherein such bleaching agent is a powder. In this usage such container member is water soluble. Such container member 2 in this embodiment is soluble in cold water as well as heated water.

Although the container member could be formed into a variety of shapes it is presently preferred that such predetermined shape of such container member 2 is substantially cubic. It is also presently preferred that such predetermined material used to form the container member 2 is gelatin.

Such container member can be formed into a variety of colors; however, it is preferred that such container member be one of pink or blue. Such container member 2 with such powdered bleach disposed therein is primarily designed for use with colored clothing although it could also be used with white clothing.

In another embodiment of the invention such bleaching agent is a liquid. In this embodiment such container member 2 when using this liquid bleach is water soluble when such water temperature reaches a predetermined temperature. It is preferred that such water temperature be at least 110 degrees Fahrenheit. This is to prevent the container member from dissolving by the action of the liquid bleach contained therein.

Although the container member 2 could be formed into a variety of shapes it is presently preferred that such predetermined shape of such container member 2 is substantially cubic. It is also presently preferred that such predetermined material used to form the container member 2 is a hard casing material. Such liquid bleaching agent is primarily designed for use with white fabrics.

It is also presently preferred that such hard casing used for such container member 2 be substantially clear.

Thus, the present invention provides a convenient new way to use bleach. The use of bleach disposed within one of a gel pack or a hard casing container offers a safer and easier way to use bleach when washing clothes. Rather then carrying heavy bottles or boxes of bleach when going to a Laundromat or even in a person's home, the present invention enables consumers to carry a small product which contains sufficient bleach for one load of clothes. The use of the packs with premeasured bleaching agent inside avoids the possibility of spilling a liquid bleach when being added to a washer or even the problem with the addition of too much or not enough bleach. Spilling of the liquid bleach can cause damage to some clothing or other items that it might contact.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

I claim:

1. A laundry device used for bleaching, said laundry device comprising:
(a) a container member having a predetermined shape and formed of a predetermined material; and
(b) a bleaching agent disposed within said container member for providing a bleaching action when dispersed in a clothes washer.

2. The laundry device according to claim 1, wherein said container member is selected from one of a gel tab and a hard casing.

3. The laundry device according to claim 2, wherein said container member is a gel tab.

4. The laundry device according to claim 3, wherein said predetermined shape of said container member is substantially cubic.

5. The laundry device according to claim 3, wherein said bleaching agent is a powder.

6. The laundry device according to claim 3, wherein said container member is water soluble.

7. The laundry device according to claim 6, wherein said container member is soluble in cold water.

8. The laundry device according to claim 5, wherein said bleaching agent is primarily designed for use with colored fabrics.

9. The laundry device according to claim 3, wherein said predetermined material of said container member is gelatin.

10. The laundry device according to claim 1, wherein said container member has a predetermined color.

11. The laundry device according to claim 10, wherein said predetermined color is one of pink and blue.

12. The laundry device according to claim 2, wherein said container member is a hard casing.

13. The laundry device according to claim 12, wherein said bleaching agent is a liquid.

14. The laundry device according to claim 13, wherein said bleaching agent is primarily designed for use with white fabrics.

15. The laundry device according to claim 13, wherein said container member when using said liquid bleach is water soluble when such water temperature reaches a predetermined temperature.

16. The laundry device according to claim 15 wherein said predetermined temperature at least 110 degrees Fahrenheit.

17. The laundry device according to claim 12, wherein said predetermined shape of said container member is substantially cubic.

18. The laundry device according to claim 15, wherein said hard casing is substantially clear.

19. The laundry device according to claim 11, wherein said bleaching agent is designed for use with white fabrics.
